(19) United States
(12) Patent Application Publication
(10) Pub. No.: US 2026/0311212 A1
(43) Pub. Date: Oct. 8, 2026

(54) METHOD, APPARATUS, DEVICE AND STORAGE MEDIUM OF PAGE INTERACTION

(71) Applicant: Beijing Youzhuju Network Technology Co., Ltd., Beijing (CN)

(72) Inventors: Yong Liu, Beijing (CN); Tong Li, Beijing (CN); Dong Liu, Beijing (CN); Lianlun Li, Beijing (CN)

(21) Appl. No.: 19/481,525

(22) PCT Filed: Aug. 21, 2024
(86) PCT No.: PCT/CN2024/113749

§ 371 Date: Nov. 4, 2025

(30) Foreign Application Priority Data
Aug. 23, 2023 (CN) 202311070288.5

(51) Int. Cl. G06Q 30/0251; G06F 3/0482; G06F 3/0484

(52) U.S. Cl. CPC G06Q 30/0253; G06F 3/0482; G06F 3/0484

(57) ABSTRACT

Embodiments of the disclosure provide a method, an apparatus, a device, and a storage medium for page interaction, which relate to the field of computer technology. The method includes: determining a target object set in response to a selection operation for at least two preset objects in a preset object set; receiving policy setting information input for a preset policy element in a promotion policy setting page for the target object set; and generating promotion policies corresponding to respective target objects in the target object set according to the policy setting information, where in the promotion policies corresponding to different target objects, at least part of element contents of the preset policy element are same.

This application claims priority of Chinese Patent Application No. 202311070288.5, filed on Aug. 23, 2023, and entitled “METHOD, APPARATUS, DEVICE AND STORAGE MEDIUM OF PAGE INTERACTION”, the entire content of which is incorporated herein by reference.

### FIELD

Embodiments of the present disclosure relates to the field of computers, and in particular, to method, apparatus, device and storage medium of page interaction.

### BACKGROUND

With the rapid development of information technology and the popularization of mobile internet, users may acquire a variety of resources through various internet-related functions, such as online shopping functions, which provides many conveniences for various aspects such as life and work of users.

### SUMMARY

Embodiments of the present disclosure provide method, apparatus, device and storage medium of page interaction, and an existing page interaction solution may be optimized.

According to a first aspect, embodiments of the present disclosure provide a method of page interaction, including: entering, in response to a trigger operation for a target object in a preset object set, a promotion policy management page of the target object; presenting, in the promotion policy management page, a promotion policy set corresponding to the target object, wherein the promotion policy set comprises at least one promotion policy, and promoter scopes in the different promotion policies are different; entering, in response to a trigger operation for a target promotion policy, a policy editing page of the target promotion policy, wherein the target promotion policy is a promotion policy in the promotion policy set.

According to a second aspect, embodiments of the present disclosure further provide an apparatus of page interaction, including: a first page entry module configured to enter, in response to a trigger operation for a target object in a preset object set, a promotion policy management page of the target object; a policy set presentation module configured to present, in the promotion policy management page, a promotion policy set corresponding to the target object, wherein the promotion policy set comprises at least one promotion policy, and promoter scopes in the different promotion policies are different; and a second page entry module configured to enter, in response to a trigger operation for a target promotion policy, a policy editing page of the target promotion policy, wherein the target promotion policy is a promotion policy in the promotion policy set.

In a third aspect, embodiments of the present disclosure further provide an electronic device, the electronic device including: one or more processors; and a storage device for storing one or more programs that when executed by the one or more processors, cause the one or more processors implement the method of page interaction provided by embodiments of the present disclosure.

According to a fourth aspect, embodiments of the present disclosure further provides a storage medium including computer-executable instructions that, when executed by a computer processor, are configured to perform the method of page interaction provided by embodiments of the present disclosure.

### BRIEF DESCRIPTION OF DRAWINGS

The above and other features, advantages, and aspects of various embodiments of the present disclosure will become more apparent in conjunction with the accompanying drawings and with reference to the following detailed description. Throughout the drawings, the same or similar reference numbers refer to the same or similar elements. It should be understood that the drawings are schematic, and components and elements are not necessarily drawn to scale.

FIG. 1 is a schematic flowchart of a page interaction method provided by embodiments of the present disclosure;

FIG. 2 is a schematic diagram of interface interaction provided by embodiments of the present disclosure;

FIG. 3 is a schematic flowchart of another page interaction method provided by embodiments of the present disclosure;

FIG. 4 is a schematic diagram of another interface interaction provided by embodiments of the present disclosure;

FIG. 5 is a schematic diagram of structure of a page interaction apparatus provided by embodiments of the present disclosure; and

FIG. 6 is a schematic diagram of structure of an electronic device provided by embodiments of the present disclosure.

### DETAILED DESCRIPTION

Embodiments of the present disclosure will be described in more detail below with reference to the accompanying drawings. Although certain embodiments of the present disclosure are shown in the drawings, it is to be understood that the present disclosure may be implemented in various forms, and should not be explained as limited to the embodiments set forth herein, and on the contrary, providing these embodiments is for understanding the present disclosure more clearly and complete. It should be understood that the drawings and embodiments of the present disclosure are only for example purposes and are not intended to limit the scope of the present disclosure.

It should be understood that the steps recited in method embodiments of the present disclosure may be performed in different orders, and/or in parallel. Further, the method embodiments may include additional steps and/or omit performing the illustrated steps. The scope of the present disclosure is not limited in this respect.

As used herein, the term “comprising” and its variant are opening comprising, i.e., “comprising but not limited to”. The term “based on” is “at least in part based on”. The term “one embodiment” means “at least one embodiment”; the term “further embodiment” means “at least one further embodiment”; the term “some embodiments” means “at least some embodiments”. The relevant definitions of other terms will be given below.

It should be noted that the concepts such as “first” and “second” mentioned in the present disclosure are merely used to distinguish different apparatuses, modules, or units, and are not intended to limit the order of functions performed by the apparatuses, modules, or units or the dependency relationship between each other.

It should be noted that the modifier of “one” and “a plurality of” mentioned in the present disclosure is illustrative and not limiting, and those skilled in the art should understand that the modifier should be understood as “one or more” unless the context clearly indicates otherwise.

The names of messages or information interacted between multiple apparatuses in embodiments of the present disclosure are for illustrative purposes only and are not intended to limit the scope of such messages or information.

It can be understood that, before the technical solutions disclosed in embodiments of the present disclosure are used, the type, the usage scope, the usage scenario of personal information related to the present disclosure and the like should be notified to the user in an appropriate manner according to the relevant laws and regulations to obtain the authorization of the user.

For example, in response to receiving an active request from a user, prompt information is sent to the user to explicitly prompt the user that the requested operation will need to obtain and use the personal information of the user. Therefore, the user may autonomously select whether to provide personal information to software or hardware such as electronic device, application program, server or storage medium that performing the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and the process of obtaining user authorization is merely illustrative, and does not constitute a limitation on implementations of the present disclosure, and other manners of meeting related laws and regulations may also be applied to implementations of the present disclosure.

It may be understood that the data involved in the technical solution (including but not limited to the data itself, the acquisition or use of the data) should follow the requirements of the corresponding laws and regulations and related rules.

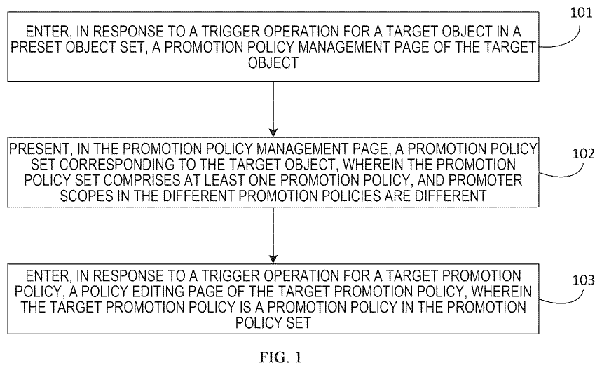

FIG. 1 is a schematic diagram of a page interaction flow provided by embodiments of the present disclosure, and embodiments of the present disclosure are appliable for the scenario of page interaction. The method may be performed by a page interaction apparatus, and the apparatus may be implemented in a form of software and/or hardware. Optionally, the electronic device is implemented by an electronic device. The electronic device may be a mobile terminal such as a mobile phone, a smart watch, a tablet computer, and a personal digital assistant, or may be device such as a personal computer (PC) terminal or a server.

As shown in FIG. 1, the method includes:

Step 101: entering, in response to a trigger operation for a target object in a preset object set, a promotion policy management page of the target object.

In embodiments of the present disclosure, the preset object set may include one or more preset objects. The preset object may be understood as a resource that may be directly or indirectly obtained by the user through a network, for example, may include a commodity, an item, a service, or the like, which may be a virtual object, or may be an entity object. With the continuous development of network technologies, more and more resources may be viewed by users through a network, and in order to help users conveniently view or obtain resources required by themselves, related technical solutions of network online promotion appear. In the network promotion scenario, the source party of the preset object may delegate the promoter to promote the preset object, and the promotion process needs to follow the promotion policy set by the provider. The source party may be understood as an operator of the preset object, for example, may be a merchant; the promoter may be understood as a main body for performing the promotion of the preset object, and providing the source party with a promotion service for the preset object, for example, may include a live streaming room account, a video blogger account or a network influencer account, and the like. The preset object set may be understood as all preset objects that may be provided by the source party or all preset objects preset for participating in promotion, and may be set according to actual needs.

As an example, a preset object set may be presented in a preset page, and the preset page may be a page in a preset application corresponding to a preset platform (for example, may be an object promotion platform), a client webpage corresponding to a preset platform, or the like, and a user of the electronic device may be a related user of the source party, that is, the preset page may be presented to a related user of the source party, for example, a page for the merchant, a related user of the merchant (for ease of description, hereinafter referred to as a merchant) may access the preset page through the merchant account, thereby implementing management of the promotion policy, such as viewing and editing. For example, the specific presentation form of the preset object set is not limited, for example, may be a list form or a matrix form. The presenting content of the preset object may include, for example, object identification information of the preset object, and the object identification information of the preset object may include, for example, an object name, an object number, an object icon, and the like, and the object icon may include a physical photo or a schematic diagram of the target object.

In the related art, since the promoter has certain diversity, it is usually necessary to divide the commodity according to the category of the promoter, for example, a common commodity and a dedicated commodity, and the common commodity may be provided to all the promoters in the platform, so that the promoter selects whether to provide the promotion service, and the dedicated commodity may be provided to the dedicated promoter specified by the merchant in the platform, so that the dedicated promoter selects whether to provide the promotion service. For common commodities and dedicated commodities, corresponding promotion plans (which may include a promoter range or an effective time range of the plan, etc.) may be made, respectively, which may be referred to as a common plan and a dedicated plan, and for common commodities, all the promoters include a dedicated promoter, and for a common promoter and a dedicated promoter, different commission plans may need to be set (which may include promotion feedback information, such as a commission calculation mode such as a fixed commission or a step commission, or a commission rate), and for a dedicated commodity, an exclusive promoter may also exist in the dedicated promoter (that is, a promoter that needs to specifically set a commission plan), and a promotion policy of a commodity needs to be determined according to a promotion plan and a commission plan together. When the merchant wants to find the promotion policy of a certain commodity, the commodity category needs to be determined firstly, then the promotion plan of the commodity is searched out in the commodity category, and under the category, the promotion plans of different commodities are mixed together, and the single commodity may also exist multiple promotion plans which are displayed dispersedly, so that it is difficult to quickly find the promotion plan that want to be viewed or edited. In addition, a commission plan suitable for the commodity of the category is searched in the commission plan list, and the commission plan is divided into a plurality of types, and the promotion policy needs to be finally determined in combination with the promotion plan and the commission plan, so that wanting to view or edit the content in the promotion policy is time and labor consumed, and the efficiency is low.

In embodiments of the present disclosure, the commodity is taken as the dimension, the category of the commodity is no longer divided, the preset object set may be directly presented, each preset object in the preset object set is no longer distinguished as a common object and a dedicated object, and the merchant may quickly select the commodity want to be viewed from the commodity, and then enter the promotion policy management page corresponding to the commodity.

For example, when the preset object set is presented, each preset object may be in a triggerable state, the merchant may input a trigger operation for a preset object in the preset object set by a preset trigger manner, the triggered preset object may be denoted as a target object, and after receiving the trigger operation, the promotion policy management page of the target object may be entered. For example, when the preset object set is presented, the presentation content for each preset object further includes a corresponding selection control, and the merchant may input the trigger operation for the preset object in the preset object set by triggering the selection control.

Optionally, presenting preset page may be switched to presenting promotion policy management page; and a promotion policy setting page may also be presented on an upper layer of the preset page, and a size of the promotion policy setting page may be smaller than a size of the preset page, and at least part of content of each preset object in the preset object set is kept in a presentation state. That is, the promotion policy management page is displayed on the upper layer of the preset page, and the size of the promotion policy management page is smaller than the size of the preset page, and at least part of the presentation content of each preset object in the preset object set is not occluded by the promotion policy management page, and the trigger operation for the preset object is supported. Therefore, in the process of viewing the promotion policy management page, the merchant may quickly achieve switching of the target object. For example, the selection control corresponding to each preset object is not occluded by the promotion policy management page, so that the target object may be quickly selected again.

Step 102: present, in the promotion policy management page, a promotion policy set corresponding to the target object. The promotion policy set comprises at least one promotion policy, and promoter scopes in the different promotion policies are different.

Optionally, the promotion policy set corresponding to the target object may be presented in a list form.

For example, the promotion policy may include a plurality of policy elements, and the policy element may include, for example, at least one of state information, a promoter scope, promotion feedback information, and a policy effective time scope. The state information may include, for example, at least one of: in effect, ended, and invalid, in the promotion policy management page, the state information corresponding to each promotion policy in the promotion policy set is presented, which helps the merchant to quickly learn the policy state; the promoter scope may be understood as a scope in which the promoter that may provide the promotion service for the target object in the object promotion platform, for example, may be all promoters or specified promoters in the platform, and may be set by the merchant according to actual needs; the promotion feedback information may be understood as cost information that needs to be paid by the merchant to delegate the promoter for promoting service, such as a commission value or a commission rate, etc.; the policy effective time scope may be understood as a time scope in which the promotion policy is in the effective state (that is, the state information of the policy is in effect), and may include an effective time and an invalid time, and a time interval formed by the effective time and the invalid time is a policy effective time scope. When the promotion policy set is presented, the policy elements in each promotion policy may be presented one by one, which facilitates the user to view comprehensive policy content. For a case in which the promotion policy set includes multiple promotion policies, the promoter scopes in different promotion policies are different.

Optionally, the method may further include: presenting, in the promotion policy management page, object identification information corresponding to the target object. For example, the object identification information corresponding to the target object may include, for example, an object name, an object number, an object icon, and the like, and the object icon may include an entity photo or a schematic diagram of the target object, and the like, which is convenient for the merchant to know the identity of the target object more intuitively. The types of the object identification information corresponding to the target object and the types of the object identification information corresponding to the preset object presented in the preset page may be the same or different, and are not specifically limited.

Step 103: enter, in response to a trigger operation for a target promotion policy, a policy editing page of the target promotion policy. The target promotion policy is a promotion policy in the promotion policy set.

For example, if the merchant wants to edit a certain promotion policy, a trigger operation may be input to the promotion policy, and the triggered promotion policy is denoted as a target promotion policy, and a specific form of the trigger operation is not limited, for example, a target promotion policy may be clicked, or an editing control of the target promotion policy may be triggered, or a certain policy element in the target promotion policy may be triggered, for example, a scope of the promoter and the like. After receiving the trigger operation, a policy editing page of the target promotion policy may be entered, and the merchant may edit the target promotion policy based on the policy editing page.

According to the page interaction method provided by embodiments of the present disclosure, the promotion policy management page of the target object is entered in response to the trigger operation for the target object in the preset object set, and the promotion policy set corresponding to the target object is presented in the promotion policy management page. The promotion policy set includes at least one promotion policy, the promoter scopes in different promotion policies are different, in response to the trigger operation for the target promotion policy, the policy editing page of the target promotion policy is entered, and the target promotion policy is a promotion policy in the promotion policy set. By applying the above technical scheme, after a certain target object is selected, the promotion policies corresponding to different promoter scopes of the target object may be aggregated and presented in the promotion policy management page, the editing of the target promotion policy in the promotion policies can be supported, the positioning efficiency of the promotion policy want to be edited can be improved, and then the promotion policy editing efficiency is improved.

In some embodiments, after entering the policy editing page of the target promotion policy, the method further includes: receiving an editing operation for a preset policy element in the target promotion policy based on the policy editing page. The preset policy element includes at least one of a promoter scope, promotion feedback information, and a policy effective time scope; and the target promotion policy is updated according to an editing result corresponding to the editing operation. Therefore, merchants may conveniently edit different preset policy elements to obtain an edited target promotion policy.

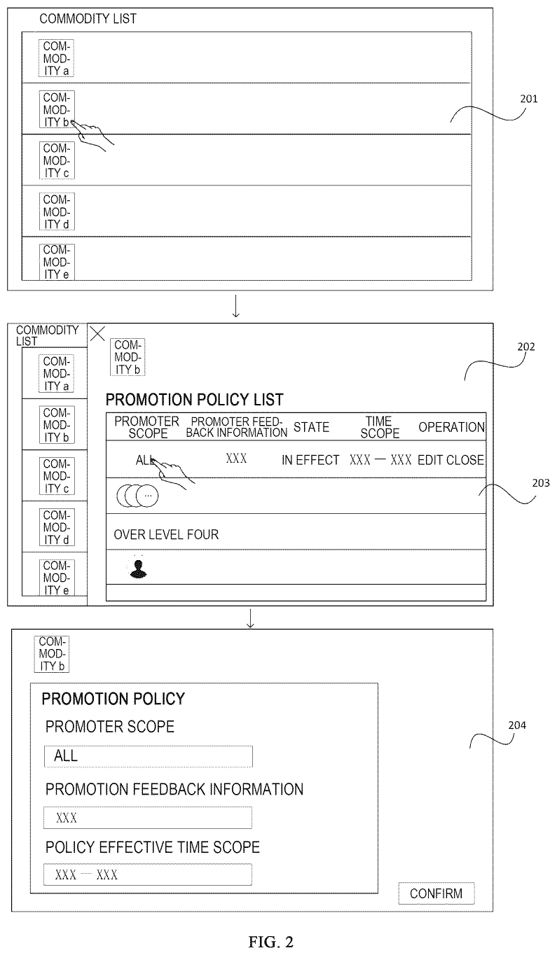

FIG. 2 is a schematic diagram of an interface interaction provided by embodiments of the present disclosure, as shown in FIG. 2, a preset object set 201 is presented in a preset page, a preset object set 201 includes a plurality of preset objects such as a commodity a, a commodity b, a commodity c, a commodity d, a commodity e, and the like (there may be a commodity f and the like, which is not shown in the figure), and the merchant may input a trigger operation by triggering a commodity icon, for example, the merchant selects the commodity b, and determines the target object as the commodity b, and enters the promotion policy management page 202 of the commodity b. As shown in FIG. 2, the promotion policy management page 202 is located on an upper layer of the preset page, a size of the promotion policy setting page 202 may be smaller than a size of the preset page, and each commodity icon in the preset object set 201 is kept in a presentation state. In the promotion policy setting page 202, a promotion policy set 203 corresponding to the commodity b is presented, where in each of the promotion policies, element content of a plurality of policy elements may be displayed, and an operation option may also be presented, where the operation option may include closing, editing, copying, deleting, or the like, and may be set according to actual requirements. When the merchant inputs a trigger operation (for example, clicking the display area of the element content of the promoter scope) for the target promotion policy (for example, the first entry in the figure) therein, the merchant enters the policy editing page 204 of the target promotion policy, in the policy editing page 204, each preset policy element may be edited, and after the editing is completed, manners such as the determination control may be triggered to trigger the update of the target promotion policy.

Optionally, after updating the target promotion policy, the method may further include: presenting an update prompt, where the update prompt is used to indicate an effective time of the updated target promotion policy, and the like. Optionally, the policy update notification may be further sent to the promoter side within the promoter scope in the target promotion policy before the update for the updated target promotion policy.

In some embodiments, receiving an editing operation for a preset policy element in the target promotion policy based on the policy editing page includes: receiving, based on the policy editing page, an editing operation for a selecting condition of a promoter scope in the target promotion policy, where the selecting condition is determined according to at least one of the promoter attribute information, the attribute information of the object historically promoted by the promoter, and the historical promotion statistical data of the promoter. Therefore, the scope of the promoter may be quickly edited according to the selecting condition.

For example, the promoter attribute information may include, for example, the promoter level information, and the promoter level information may be measured based on the promotion service quality provided by the promoter. The attribute information of the object historically promoted by the promoter may include, for example, a type of an object that has been promoted in a recent promotion period (for example, the last month), for example, a commodity category. The historical promotion statistical data may include, for example, a cumulative object promotion number in a promotion period (for example, the last month), or a cumulative value obtained by object promotion, and the like.

In some embodiments, the promoter scope corresponds to at least two setting modes with different priorities, and in case of there are at least two promotion policies corresponding to the promoter scopes of different setting modes in the promotion policy set, if the target promoter is in the promoter scopes of the different setting modes at the same time, the promotion feedback information and/or the policy effective time scope applicable to the target promoter is determined according to the promotion policy to which the promoter scope of the setting mode with the highest priority belongs. Therefore, by setting the priority of the promoter scope, when the scope of the promoter is edited, the intersection situation of the scope of the promoter in each promotion policy does not need to be considered, and compared with the related technical scheme of setting the plurality of promotion policies of the intersection of the promoter not existing, the scope of the promoter of one promotion policy is adjusted, the scope of the promoter of other associated promotion policies does not need to be adjusted, the setting efficiency may be improved, and the number of the promotion policies may be effectively reduced.

For example, the priority of the specified promoter scope is higher than the promoter scope determined according to the selecting condition, and the priority of the promoter scope determined according to the selecting condition is higher than the priority of all the promoters.

In some embodiments, the method further includes: presenting, in the promotion policy management page, a preset control corresponding to a promotion policy in the promotion policy set; in response to a trigger operation of a target preset control, entering a policy creation page corresponding to the target object; and filling element content of the preset policy element in the promotion policy corresponding to the target preset control in a setting area of the preset policy element in the policy creation page. Therefore, the policy copy function may be provided, the element content in the promotion policy that currently needs to be copied may be automatically filled into the policy creation page by triggering the preset control, the merchant may quickly generate a new promotion policy through a small amount of adjustment, and the efficiency of creating the promotion policy is improved.

For example, the promotion policy allowed to be copied may be preset, for example, the promotion policy at the preset state is allowed to be copied, that is, the preset control corresponding to the promotion policy at the preset state in the promotion policy set is presented. The preset state may be, for example, an ended state or an invalid state, and the like, which is not specifically limited.

In some embodiments, the method further includes: presenting, in the promotion policy management page, the promoter coverage rate information corresponding to the target object. The promoter coverage rate information is determined according to a ratio of a target promoter scope to a preset promoter scope, and the target promotion scope includes a union set of a promoter scope corresponding to a promotion policy in effect in the promotion policy set. Therefore, the merchant may be helped to automatically count the coverage rate information of the promoter, and the merchant may be helped to quickly and reasonably adjust the scope of the promoter.

For example, the preset promoter scope may include all the promoters of the platform, assuming that all the promoters are 1000, and if the scope of the promoter is set to be all the promoters, the coverage information of the promoter is 100%, if there are two promotion policies currently in effect, the promoter scope in the first promotion policy determines 100 promoters through the selecting condition, the promoter scope in the second promotion policy determines 200 promoters through the selecting condition, and there are 50 repeated promoters in the 100 promoters and the 200 promoters, then there are 250 promoters in combination, and the coverage of the promoter is 25%.

In some embodiments, the method further includes: presenting, in the promotion policy management page, promotion statistical data of a promoter corresponding to the target object. Therefore, the merchant may be helped to view the promotion statistical data of the promoter in the commodity dimension, and the user experience on the merchant side is improved.

For example, the promotion statistical data may include, for example, the number of promotion delegated promoters that have been viewed, the number of promoters that have received the promotion delegates, the number of promoters that have reached a preset promotion target (for example, at least one target commodity is sold after promotion), the total number of completed ownership transfers (for example, sales) of the target object, and a total cost (total sales) of completed ownership transfer of the target object.

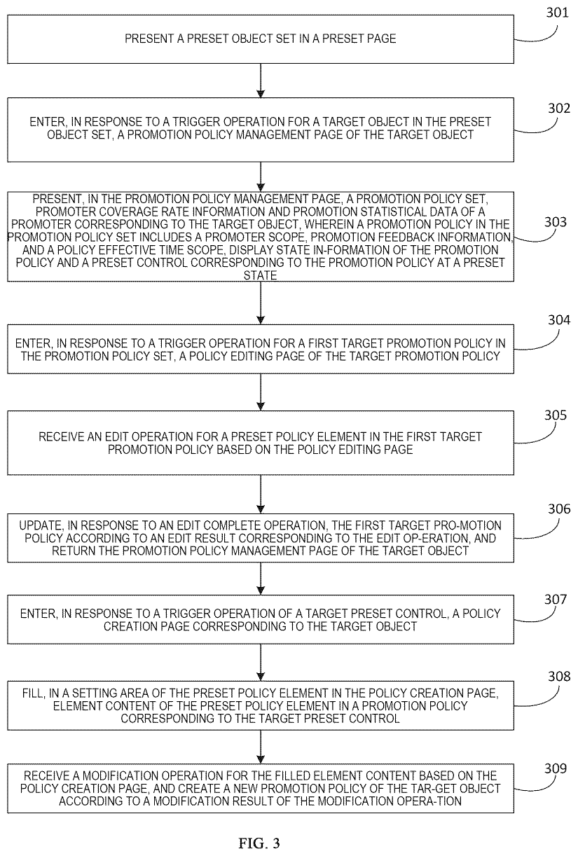

FIG. 3 is a schematic flowchart of a page interaction method provided by embodiments of the present disclosure, and embodiments of the present disclosure are optimized based on various optional solutions in above embodiments. Specifically, the method includes the following steps:

Step 301, present a preset object set in a preset page.

For example, taking the promotion policy of the merchant management commodity as an example, the preset page may present a commodity list provided by the merchant that needs to be promoted.

Step 302: enter, in response to a trigger operation for a target object in the preset object set, a promotion policy management page of the target object.

For example, the merchant may select, from the commodity list according to actual requirements, a commodity that the promotion policy currently required to be viewed or edited.

Step 303: present, in the promotion policy management page, a promotion policy set, promoter coverage rate information and promotion statistical data of a promoter corresponding to the target object, wherein a promotion policy in the promotion policy set includes a promoter scope, promotion feedback information, and a policy effective time scope, display state information of the promotion policy and a preset control corresponding to the promotion policy at a preset state.

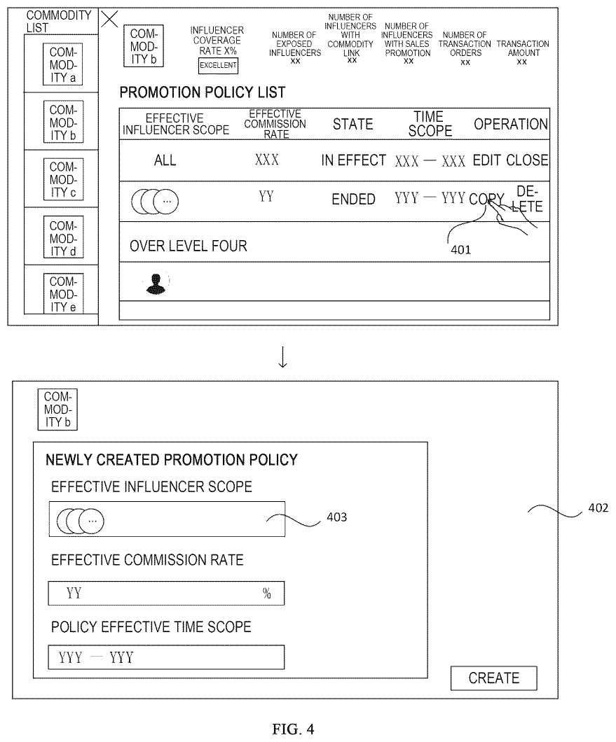

FIG. 4 is a schematic diagram of another interface interaction provided by embodiments of the present disclosure, as shown in FIG. 4, after entering the promotion policy management page, the promotion policy set (promotion policy list as shown in the figure) corresponding to the commodity b, promoter coverage rate information (influencer coverage rate x % shown in figure, and the level is excellent), and promotion statistical data (number of exposed influencers, number of influencers with commodity link, number of influencers with sales promotion, number of transaction orders and transaction amount) of the promoter are presented. The promotion policy in the promotion policy set includes a promoter scope (effective influencer scope), promotion feedback information (effective commission rate), and a policy effective time scope (time scope), state information (such as in effect, ended, etc.) of the presented promotion policy and a preset control corresponding to the promotion policy in the preset state (the copy control 401 in the operation option).

Step 304: enter, in response to a trigger operation for a first target promotion policy in the promotion policy set, a policy editing page of the target promotion policy.

Step 305: receive an edit operation for a preset policy element in the first target promotion policy based on the policy editing page.

Step 306, update, in response to an edit complete operation, the first target promotion policy according to an edit result corresponding to the edit operation, and return the promotion policy management page of the target object.

Step 307: enter, in response to a trigger operation of a target preset control, a policy creation page corresponding to the target object.

For example, as shown in FIG. 4, for the second promotion policy in the promotion policy list, the state of the promotion policy is ended, and if the merchant wants to use all or some of the policy element content in the promotion policy again, and the policy creation page 402 of entering the commodity b may be triggered the corresponding copy control 401.

Step 308: fill, in a setting area of the preset policy element in the policy creation page, element content of the preset policy element in a promotion policy corresponding to the target preset control.

As shown in FIG. 4, after entering the policy creation page 402 of the commodity b, the setting area 403 of each preset policy element is displayed in the policy creation page 402, and the element content of each preset policy element in the second promotion policy is automatically filled into the corresponding setting area.

Step 309: receive a modification operation for the filled element content based on the policy creation page, and create a new promotion policy of the target object according to a modification result of the modification operation.

Optionally, if the merchant wants to completely use the element content in the copied promotion policy again, the newly create operation may be directly triggered to generate a corresponding new promotion policy; if the merchant wants to make modification based on the copied promotion policy, the modification operation may be input for the filled element content, and after the newly create operation is triggered, the new promotion policy of the target object is created according to the modification result of the modification operation.

According to the page interaction method provided by embodiments of the present disclosure, the preset object set is presented in the preset page, the merchant user may input the trigger operation for the preset object which wants to edit the promotion policy in the preset object set, and the promotion policy management page of the triggered target object is entered, the promotion policy set, the promoter coverage rate information and the promotion statistical data of the promoter corresponding to the target object are presented in the promotion policy management page, which helps the merchant to comprehensively know the overall condition of the promotion policy setting of the target object and the implementation condition of the promotion policy, so that the target promotion policy that needs to be edited is selected more efficiently, after triggering the target promotion policy, the policy editing page of the target promotion policy is entered, and the policy element content is edited so as to quickly update the promotion policy. In addition, by triggering the preset control, the element content in the promotion policy that currently needs to be copied may be automatically filled into the policy creation page, the merchant may quickly generate a new promotion policy through a small amount of adjustment, to improve the creating efficiency of the promotion policy, and the management efficiency of the promotion policy is overall improved.

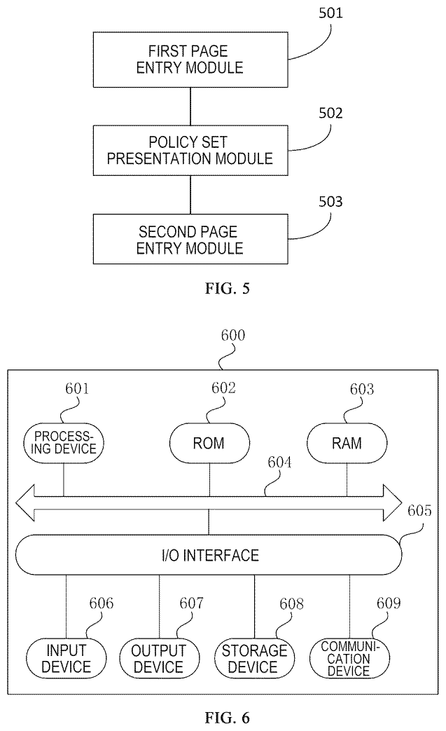

FIG. 5 is a schematic diagram of structure of a page interaction apparatus provided by embodiments of the present disclosure, as shown in FIG. 5, the apparatus includes: a first page entry module 501, configured to enter, in response to a trigger operation for a target object in a preset object set, a promotion policy management page of the target object; a policy set display module 502, configured to present, in the promotion policy management page, a promotion policy set corresponding to the target object, wherein the promotion policy set comprises at least one promotion policy, and promoter scopes in the different promotion policies are different; and a second page entry module 503, configured to enter, in response to a trigger operation for a target promotion policy, a policy editing page of the target promotion policy. The target promotion policy is a promotion policy in the promotion policy set.

The page interaction apparatus provided by embodiments of the present disclosure enters, in response to a trigger operation for a target object in a preset object set, a promotion policy management page of the target object, presents, in the promotion policy management page, a promotion policy set corresponding to the target object. The promotion policy set comprises at least one promotion policy, and promoter scopes in the different promotion policies are different, the page interaction apparatus enters, in response to a trigger operation for a target promotion policy, a policy editing page of the target promotion policy, and the target promotion policy is a promotion policy in the promotion policy set. By applying the above technical solution, after a certain target object is selected, the promotion policies corresponding to different promoter ranges of the target object may be aggregated and presented in the promotion policy management page, and the editing of the target promotion policy in which may be supported, and the positioning efficiency of the promotion policy for editing may be improved, to improve the promotion policy editing efficiency.

Optionally, the apparatus further includes: an editing module, configured to after entering the policy editing page of the target promotion policy, receive an edit operation for a preset policy element in the target promotion policy based on the policy editing page, wherein the preset policy element comprises at least one of: a promoter scope, promotion feedback information, and a policy effective time scope; and a policy updating module, configured to update the target promotion policy according to an edit result corresponding to the edit operation.

Optionally, the editing module includes: an editing unit, configured to receive an edit operation for a selecting condition of the promoter scope in the target promotion policy based on the policy editing page, wherein the selecting condition is determined according to at least one of: promoter attribute information, attribute information of an object historically promoted by the promoter, and historical promotion statistical data of the promoter.

Optionally, the promoter scope corresponds to at least two setting modes with different priorities, and in accordance with that at least two promotion policies of the promoter scope corresponding to different setting modes exist in the promotion policy set, in response to a target promoter located in the promoter scope of the different setting modes at the same time, promotion feedback information and/or a policy effective time scope applicable to the target promoter is determined based on a promotion policy to which a promoter scope of a setting mode with the highest priority belongs; and/or, the preset object set is presented in a preset page, the promotion policy management page is displayed on an upper layer of the preset page, a size of the promotion policy management page is smaller than a size of the preset page, and at least part of presentation content of each preset object in the preset object set is not occluded by the promotion policy management page.

Optionally, the apparatus further includes: a preset control presenting module, configured to present, in the promotion policy management page, a preset control corresponding to a promotion policy in the promotion policy set; a third page entry module, configured to enter, in response to a trigger operation of a target preset control, a policy creation page corresponding to the target object; and a content filling module, configured to fill, in a setting area of the preset policy element in the policy creation page, element content of the preset policy element in a promotion policy corresponding to the target preset control.

Optionally, the apparatus further includes: a state presenting module, configured to present, in the promotion policy management page, state information corresponding to each promotion policy in the promotion policy set, wherein the state information comprises at least one of: in effect, ended, and invalid.

Optionally, the apparatus further includes: a coverage rate presenting module, configured to present, in the promotion policy management page, promoter coverage rate information corresponding to the target object, wherein the promoter coverage rate information is determined according to a ratio of a target promoter scope to a preset promoter scope, and the target promotion scope comprises a union set of promoter scopes corresponding to promotion policies in effect in the promotion policy set.

Optionally, the apparatus further includes: a statistical data presenting module, configured to present, in the promotion policy management page, promotion statistical data of a promoter corresponding to the target object.

The page interaction apparatus provided by embodiments of the present disclosure may perform the page interaction method provided by any embodiment of the present disclosure, and has functional modules and beneficial effects corresponding to the execution method.

It should be noted that the units and modules included in the foregoing apparatus are only divided according to the function logic, but are not limited to the foregoing division, as long as the corresponding functions can be implemented; in addition, the specific names of the various functional units are merely for ease of distinguishing, and are not intended to limit the protection scope of embodiments of the present disclosure.

FIG. 6 is a schematic diagram of structure of an electronic device provided by embodiments of the present disclosure. Referring to FIG. 6, FIG. 6 illustrates a schematic diagram of structure of an electronic device 600 (such as the terminal device or server in FIG. 6) suitable for implementing embodiments of the present disclosure. The terminal device in embodiments of the present disclosure may include, but are not limited to, mobile terminals such as mobile phones, notebook computers, digital broadcast receivers, PDA (personal digital assistant), PAD (portable Android device), PMP (portable multimedia player), vehicle-mounted terminals (such as vehicle-mounted navigation terminals), etc., as well as fixed terminals such as digital television (TV), desktop computers, etc. The electronic device shown in FIG. 6 is only an example, and should not limit the function and using scope of embodiments of the present disclosure.

As shown in FIG. 6, the electronic device 600 may include a processing device (such as a central processing unit, a graphics processing unit, or the like) 601 that may perform various appropriate actions and processing according to a program stored in a read only memory (ROM) 602 or a program loaded from a storage device 608 into a random access memory (RAM) 603. In the RAM 603, various programs and data required for operation of the electronic device 600 are further stored. The processing device 601, the ROM 602, and the RAM 603 are connected to each other by using a bus 604. An edit/output (I/O) interface 605 is also connected to the bus 604.

Generally, the following devices may be connected to the I/O interface 605: input device 606 including, for example, a touchscreen, a touchpad, a keyboard, a mouse, a camera, a microphone, an accelerometer, and a gyroscope; output device 607 including, for example, a liquid crystal display (LCD), a loudspeaker and a vibrator; storage device 608 including, for example, a tape or a hard disk; and a communication device 609. The communication device 609 may allow the electronic device 600 to communicate wirelessly or wired with another device to exchange data. Although FIG. 6 shows an electronic device 600 with various devices, it should be understood that it is not required to implement or provide all shown devices. Alternatively, more or fewer devices may be implemented or provided.

In particular, according to embodiments of the present disclosure, the process described above with reference to the flowchart may be implemented as a computer software program. For example, an embodiment of the present disclosure includes a computer software program product that includes a computer program carried on a non-transitory computer readable medium, and the computer program includes program codes used to perform the methods shown in the flowchart. In such an embodiment, the computer program may be downloaded and installed from a network by using the communications device 609, or installed from the storage device 608, or installed from the ROM 602. When the computer program is executed by the processing device 601, the foregoing functions defined in the method in embodiments of the present disclosure are executed.

The names of messages or information exchanged between multiple apparatuses in embodiments of the present disclosure are for illustrative purposes only and are not used to limit the scope of these messages or information.

The electronic device provided by embodiments of the present disclosure and the page interaction method provided in the foregoing embodiments belong to the same inventive concept, technical details not described in detail in this embodiment may refer to the foregoing embodiments, and this embodiment has the same beneficial effects as the foregoing embodiments.

Embodiments of the present disclosure provides a computer storage medium having a computer program stored thereon, and the program, when executed by a processor, implements the page interaction method provided in the foregoing embodiments.

Embodiments of the present disclosure provides a computer program product, including a computer program, and when the program is executed by a processor, the page interaction method provided in the foregoing embodiments is implemented.

It should be noted that the foregoing computer-readable medium in the present disclosure may be a computer-readable signal medium, a computer-readable storage medium, or any combination of the two. The computer-readable storage medium may be, for example, an electrical, magnetic, optical, electromagnetic, infrared, or semiconductor system, apparatus, or means, or any combination thereof. More specific examples of the computer-readable storage medium may include but are not limited to: an electrical connection having one or more conducting wires, a portable computer disk, a hard disk, a random-access memory (RAM), a read-only memory (ROM), an erasable programmable read only memory (EPROM or flash memory), an optical fiber, a portable compact disk read only memory (CD-ROM), an optical storage device, a magnetic storage device, or any suitable combination thereof. In the present disclosure, the computer-readable storage medium may be any tangible medium that includes or stores a program, and the program may be used by or in combination with an instruction execution system, apparatus, or means. In addition, in the present disclosure, the computer-readable signal medium may include a data signal propagated in a baseband or as a part of a carrier, which carries computer-readable program codes. Such a propagated data signal may be in multiple forms, including but not limited to an electromagnetic signal, an optical signal, or any suitable combination thereof. The computer-readable signal medium may further be any computer-readable medium other than the computer-readable storage medium, and the computer-readable signal medium may send, propagate, or transmit a program that is used by or in combination with an instruction execution system, apparatus, or means. The program code included in the computer-readable medium may be transmitted by using any suitable medium, including but not limited to: a wire, an optical cable, radio frequency (RF), or any suitable combination thereof.

In some implementations, the client and the server may communicate using any currently known or future developed network protocol, such as HTTP (HyperText Transfer Protocol), and may be interconnected with any form or medium of digital data communication (e.g., a communication network). Examples of communication networks include local area networks (“LANs”), wide area networks (“WANs”), internets (e.g., the Internet), and peer-to-peer networks (e.g., ad hoc peer-to-peer networks), as well as any currently known or future developed networks.

The foregoing computer-readable medium may be included in the foregoing electronic device; it may also exist separately without being assembled into the electronic device.

The foregoing computer-readable medium carries one or more programs, when the foregoing one or more programs are executed by the electronic device, causing the electronic device to: enter, in response to a trigger operation for a target object in a preset object set, a promotion policy management page of the target object; present, in the promotion policy management page, a promotion policy set corresponding to the target object, where the promotion policy set comprises at least one promotion policy, and promoter scopes in the different promotion policies are different; enter, in response to a trigger operation for a target promotion policy, a policy editing page of the target promotion policy, where the target promotion policy is a promotion policy in the promotion policy set.

Computer program codes for performing the operations of the present disclosure may be written in one or more programming languages or a combination thereof, including but not limited to object oriented programming languages, such as Java, Smalltalk, C++, and conventional procedural programming languages such as “C” or similar program design languages. The program codes may be executed completely on a user computer, partially on a user computer, as an independent package, partially on a user computer and partially on a remote computer, or completely on a remote computer or server. In cases involving a remote computer, the remote computer may be connected to a user computer through any type of network, including a local area network (LAN) or a wide area network (WAN), or may be connected to an external computer (for example, through the Internet by using an Internet service provider).

The flowcharts and block diagrams in the accompanying drawings illustrate possible architectures, functions, and operations of systems, methods, and computer program products according to various embodiments of the present disclosure. In this regard, each block in a flowchart or block diagram may represent a module, program segment, or part of code that includes one or more executable instructions for implementing a specified logical function. It should also be noted that in some alternative implementations, functions marked in the block may also occur in different order than those marked in the accompanying drawings. For example, two blocks represented in succession may actually be executed in substantially parallel, and they may sometimes be executed in a reverse order, depending on the functions involved. It should also be noted that each block in the block diagram and/or flowchart and a combination of blocks in the block diagram and/or flowchart may be implemented by using a dedicated hardware-based system that performs a specified function or operation, or may be implemented by using a combination of dedicated hardware and a computer instruction.

The units involved in embodiments described in the present disclosure may be implemented either by means of software or by means of hardware. The names of these modules do not limit the modules themselves under certain circumstances, for example, the first page entry module may also be described as “module for entering, in response to a trigger operation for a target object in a preset object set, a promotion policy management page of the target object”.

The functions described above herein may be performed, at least in part, by one or more hardware logic components. For example, and without limitation, example types of hardware logic components that may be used include: field programmable gate arrays (FPGAs), application specific integrated circuits (ASICs), application specific standard product (ASSP), systems on a chip (SOC), complex programmable logical device (CPLD) and so on.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. Machine-readable media may include, but are not limited to, electronic, magnetic, optical, electromagnetic, infrared, or semiconductor systems, apparatus or device, or any suitable combination of the foregoing. More specific examples of machine-readable storage media would include one or more wire-based electrical connection, portable computer disks, hard disks, random access memory (RAM), read only memory (ROM), erasable programmable read only memory (EPROM or flash memory), optical fiber, portable compact disk read-only memory (CD-ROM), optical storage device, magnetic storage device, or any suitable combination of the foregoing content.

According to one or more embodiments of the present disclosure, a method of page interaction is provided, comprising: entering, in response to a trigger operation for a target object in a preset object set, a promotion policy management page of the target object; presenting, in the promotion policy management page, a promotion policy set corresponding to the target object, wherein the promotion policy set comprises at least one promotion policy, and promoter scopes in the different promotion policies are different; entering, in response to a trigger operation for a target promotion policy, a policy editing page of the target promotion policy, wherein the target promotion policy is a promotion policy in the promotion policy set.

According to one or more embodiments of the present disclosure, after entering the policy editing page of the target promotion policy, the method further comprises: receiving an edit operation for a preset policy element in the target promotion policy based on the policy editing page, wherein the preset policy element comprises at least one of: a promoter scope, promotion feedback information, and a policy effective time scope; updating the target promotion policy according to an edit result corresponding to the edit operation.

According to one or more embodiments of the present disclosure, receiving the edit operation for the preset policy element in the target promotion policy based on the policy editing page comprises: receiving an edit operation for a selecting condition of the promoter scope in the target promotion policy based on the policy editing page, wherein the selecting condition is determined according to at least one of: promoter attribute information, attribute information of an object historically promoted by the promoter, and historical promotion statistical data of the promoter.

According to one or more embodiments of the present disclosure, the promoter scope corresponds to at least two setting modes with different priorities, and in accordance with that at least two promotion policies of the promoter scope corresponding to different setting modes exist in the promotion policy set, in response to a target promoter located in the promoter scope of the different setting modes at the same time, promotion feedback information and/or a policy effective time scope applicable to the target promoter is determined based on a promotion policy to which a promoter scope of a setting mode with the highest priority belongs; and/or, the preset object set is presented in a preset page, the promotion policy management page is displayed on an upper layer of the preset page, a size of the promotion policy management page is smaller than a size of the preset page, and at least part of presentation content of each preset object in the preset object set is not occluded by the promotion policy management page.

According to one or more embodiments of the present disclosure, the method further includes: presenting, in the promotion policy management page, a preset control corresponding to a promotion policy in the promotion policy set; entering, in response to a trigger operation of a target preset control, a policy creation page corresponding to the target object; filling, in a setting area of the preset policy element in the policy creation page, element content of the preset policy element in a promotion policy corresponding to the target preset control.

According to one or more embodiments of the present disclosure, the method further includes: presenting, in the promotion policy management page, state information corresponding to each promotion policy in the promotion policy set, wherein the state information comprises at least one of: in effect, ended, and invalid; and/or, presenting, in the promotion policy management page, promoter coverage rate information corresponding to the target object, wherein the promoter coverage rate information is determined according to a ratio of a target promoter scope to a preset promoter scope, and the target promotion scope comprises a union set of promoter scopes corresponding to promotion policies in effect in the promotion policy set.

According to one or more embodiments of the present disclosure, the method further includes: presenting, in the promotion policy management page, promotion statistical data of a promoter corresponding to the target object.

According to one or more embodiments of the present disclosure, an apparatus of page interaction is provided, including: a first page entry module configured to enter, in response to a trigger operation for a target object in a preset object set, a promotion policy management page of the target object; a policy set presentation module configured to present, in the promotion policy management page, a promotion policy set corresponding to the target object, wherein the promotion policy set comprises at least one promotion policy, and promoter scopes in the different promotion policies are different; and a second page entry module configured to enter, in response to a trigger operation for a target promotion policy, a policy editing page of the target promotion policy, wherein the target promotion policy is a promotion policy in the promotion policy set.

According to one or more embodiments of the present disclosure, an electronic device is provided, the electronic device comprising: one or more processors; a storage device storing one or more programs, the one or more programs, when executed by the one or more processors, causing the one or more processors to implement the method of page interaction provided by embodiments of the present disclosure.

According to one or more embodiments of the present disclosure, there is provided a storage medium including computer executable instructions that, when executed by a computer processor, configured to perform the method of page interaction provided by embodiments of the present disclosure.

The above description is only embodiments of the present disclosure and an illustration of the technical principles utilized. It should be understood by those skilled in the art that the scope of disclosure involved in the present disclosure is not limited to technical solutions formed by a particular combination of the above technical features, but also covers other technical solutions formed by any combination of the above technical features or their equivalent features without departing from the above disclosed concept, for example, a technical solution formed by interchanging the above features with (but not limited to) technical features with similar functions disclosed in the present disclosure.

Further, although the operations are depicted using a particular order, this should not be construed as requiring that the operations be performed in the particular order shown or in sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject has been described using language specific to structural features and/or method logical actions, it should be understood that the subject limited in the appended claims is not necessarily limited to the particular features or actions described above. Rather, the particular features and actions described above are merely example forms of implementing the claims.

1. A method for page interaction, comprising:
determining a target object set in response to a selection operation for at least two preset objects in a preset object set, wherein target objects in the target object set comprise the at least two preset objects;
receiving policy setting information input for a preset policy element in a promotion policy setting page for the target object set; and
generating promotion policies corresponding to respective target objects in the target object set according to the policy setting information, wherein in the promotion policies corresponding to different target objects, at least part of element contents of the preset policy element are same.

2. The method of claim 1, wherein the preset policy element comprises at least one of a promoter scope, promotion feedback information, or a policy validity time range.

3. The method of claim 1, further comprising:
displaying, in the promotion policy setting page, object identification information corresponding to respective target objects in the target object set.

4. The method of claim 1, further comprising:
displaying at least two policy labels in the promotion policy setting page, wherein the at least two policy labels comprise a first policy label and a second policy label, the first policy label being configured to trigger display of a setting area of a promotion policy being set, the setting area being configured to receive and/or view the policy setting information, and the second policy label being configured to trigger addition of a first policy label.

5. The method of claim 1, further comprising:
displaying, in the promotion policy setting page, a first setting control and a second setting control corresponding to a target policy element in the preset policy element, wherein the first setting control is configured to trigger display of a unified setting input area of the target policy element corresponding to the target object set, and the second setting control is configured to trigger display of independent setting input areas of the target policy element corresponding to respective target objects in the target object set.

6. The method of claim 2, wherein receiving the policy setting information input for the preset policy element in the promotion policy setting page for the target object set comprises:
receiving, in the promotion policy setting page for the target object set, setting information of a filtering condition input for a promoter scope, and determining the setting information of the filtering condition as promoter scope setting information corresponding to the target object set, wherein the filtering condition is determined according to at least one of promoter attribute information, attribute information of an object historically promoted by the promoter, or historical promotion statistics of the promoter;
and/or,
the method further comprises:
displaying, in the promotion policy setting page, promoter coverage information corresponding to a set promotion policy corresponding to the target object set, wherein the promoter coverage information is determined according to a ratio between a target promoter scope and a preset promoter scope, and the target promotion scope comprises a union of promoter scopes corresponding to the set promotion policy.

7. The method of claim 1, further comprising:
displaying, in the promotion policy setting page, a preview image of an effective page of the promotion policy corresponding to the target object, wherein the effective page is configured to display to a promoter in the promotion policy corresponding to the target object.

8. (canceled)

9. An electronic device, comprising:
one or more processors,
a storage apparatus, configured to store one or more programs,
when the one or more programs are executed by the one or more processors, the one or more processors are caused to perform operations comprising:
determining a target object set in response to a selection operation for at least two preset objects in a preset object set, wherein target objects in the target object set comprise the at least two preset objects;
receiving policy setting information input for a preset policy element in a promotion policy setting page for the target object set; and
generating promotion policies corresponding to respective target objects in the target object set according to the policy setting information, wherein in the promotion policies corresponding to different target objects, at least part of element contents of the preset policy element are same.

10. A non-transitory storage medium comprising computer-executable instructions that, when executed by a computer processor, causing operations to be performed, the operations comprising:
determining a target object set in response to a selection operation for at least two preset objects in a preset object set, wherein target objects in the target object set comprise the at least two preset objects;
receiving policy setting information input for a preset policy element in a promotion policy setting page for the target object set; and
generating promotion policies corresponding to respective target objects in the target object set according to the policy setting information, wherein in the promotion policies corresponding to different target objects, at least part of element contents of the preset policy element are same.

11. The electronic device of claim 9, wherein the preset policy element comprises at least one of a promoter scope, promotion feedback information, or a policy validity time range.

12. The electronic device of claim 9, wherein the operations further comprise:
displaying, in the promotion policy setting page, object identification information corresponding to respective target objects in the target object set.

13. The electronic device of claim 9, wherein the operations further comprise:
displaying at least two policy labels in the promotion policy setting page, wherein the at least two policy labels comprise a first policy label and a second policy label, the first policy label being configured to trigger display of a setting area of a promotion policy being set, the setting area being configured to receive and/or view the policy setting information, and the second policy label being configured to trigger addition of a first policy label.

14. The electronic device of claim 9, wherein the operations further comprise:
displaying, in the promotion policy setting page, a first setting control and a second setting control corresponding to a target policy element in the preset policy element, wherein the first setting control is configured to trigger display of a unified setting input area of the target policy element corresponding to the target object set, and the second setting control is configured to trigger display of independent setting input areas of the target policy element corresponding to respective target objects in the target object set.

15. The electronic device of claim 11, wherein receiving the policy setting information input for the preset policy element in the promotion policy setting page for the target object set comprises:
receiving, in the promotion policy setting page for the target object set, setting information of a filtering condition input for a promoter scope, and determining the setting information of the filtering condition as promoter scope setting information corresponding to the target object set, wherein the filtering condition is determined according to at least one of promoter attribute information, attribute information of an object historically promoted by the promoter, or historical promotion statistics of the promoter;
and/or,
the operations further comprise:
displaying, in the promotion policy setting page, promoter coverage information corresponding to a set promotion policy corresponding to the target object set, wherein the promoter coverage information is determined according to a ratio between a target promoter scope and a preset promoter scope, and the target promotion scope comprises a union of promoter scopes corresponding to the set promotion policy.

16. The electronic device of claim 9, wherein the operations further comprise:
displaying, in the promotion policy setting page, a preview image of an effective page of the promotion policy corresponding to the target object, wherein the effective page is configured to display to a promoter in the promotion policy corresponding to the target object.

17. The non-transitory storage medium of claim 10, wherein the preset policy element comprises at least one of a promoter scope, promotion feedback information, or a policy validity time range.

18. The non-transitory storage medium of claim 10, wherein the operations further comprise:
displaying, in the promotion policy setting page, object identification information corresponding to respective target objects in the target object set.

19. The non-transitory storage medium of claim 10, wherein the operations further comprise:
displaying at least two policy labels in the promotion policy setting page, wherein the at least two policy labels comprise a first policy label and a second policy label, the first policy label being configured to trigger display of a setting area of a promotion policy being set, the setting area being configured to receive and/or view the policy setting information, and the second policy label being configured to trigger addition of a first policy label.

20. The non-transitory storage medium of claim 10, wherein the operations further comprise:
displaying, in the promotion policy setting page, a first setting control and a second setting control corresponding to a target policy element in the preset policy element, wherein the first setting control is configured to trigger display of a unified setting input area of the target policy element corresponding to the target object set, and the second setting control is configured to trigger display of independent setting input areas of the target policy element corresponding to respective target objects in the target object set.

21. The non-transitory storage medium of claim 17, wherein receiving the policy setting information input for the preset policy element in the promotion policy setting page for the target object set comprises:
receiving, in the promotion policy setting page for the target object set, setting information of a filtering condition input for a promoter scope, and determining the setting information of the filtering condition as promoter scope setting information corresponding to the target object set, wherein the filtering condition is determined according to at least one of promoter attribute information, attribute information of an object historically promoted by the promoter, or historical promotion statistics of the promoter;
and/or,
the operations further comprise:
displaying, in the promotion policy setting page, promoter coverage information corresponding to a set promotion policy corresponding to the target object set, wherein the promoter coverage information is determined according to a ratio between a target promoter scope and a preset promoter scope, and the target promotion scope comprises a union of promoter scopes corresponding to the set promotion policy.
